(19) United States
(12) Patent Application Publication
(10) Pub. No.: US 2023/0402721 A1
(43) Pub. Date: Dec. 14, 2023

(54) Bipole Frame with Improved Solid Electrical Connection and Bipolar Batteries Including the Same

(71) Applicant: EnerSys Delaware Inc., Reading, PA (US)

(72) Inventors: Stephen Bryan, Midland, MI (US); Paul J. Melichar, Midland, MI (US)

(21) Appl. No.: 18/330,712

(22) Filed: Jun. 7, 2023

Related U.S. Application Data
(60) Provisional application No. 63/350,144, filed on Jun. 8, 2022.

(51) Int. Cl. H01M 50/529; H01M 10/18; H01M 50/536; H01M 50/571; H01M 10/12

(52) U.S. Cl. CPC H01M 50/529; H01M 10/18; H01M 50/536; H01M 50/571; H01M 10/12

(57) ABSTRACT

A method of assembling a bipole frame assembly for a bipolar battery, includes: providing a bipole frame including first and second opposite surfaces and a plurality of through holes; receiving a shaft of an electrical joint in each through hole such that a first head of the electrical joint is on the first surface of the bipole frame; and compressing a distal end of the shaft to form a second head of the electrical joint that is on the second surface of the bipole frame, the second head having a diameter greater than that of the shaft and the shaft completely filling the through hole.

### RELATED APPLICATIONS

This application claims priority from U.S. Provisional Application Ser. No. 63/350,144, filed Jun. 8, 2022, the disclosure of which is incorporated by reference in its entirety.

### BACKGROUND

In some known bipolar batteries, solder joints are used to join lead sheets on opposite sides of the bipole frame. The solder joint is formed in the bipole frame's through-hole. However, an inadequate fill of the solder joint within the bipole frame can cause two potential defects: 1) high electrical resistance; and 2) electrolyte communication between adjacent half cells. In addition, solder alloys with low enough reflow temperatures to work with polymer bipole frames have been shown to have higher corrosion rates.

### SUMMARY

Some embodiments of the present invention are directed to a method of assembling a bipole frame assembly for a bipolar battery. The method includes: providing a bipole frame including first and second opposite surfaces and a plurality of through holes; receiving a shaft of a solid electrical joint in each through hole such that a first head of the electrical joint is on the first surface of the bipole frame; and compressing a distal end of the shaft to form a second head of the electrical joint that is on the second surface of the bipole frame and to completely fill the through hole with the shaft.

In some embodiments, the method includes: placing a first bipole lead sheet on the first surface of the bipole frame and each first head of the electrical joints; and placing a second bipole lead sheet on the second surface of the bipole frame and each second head of the electrical joints. The method may further include welding at the electrical joints to enhance a connection between the first and second lead sheets and the electrical joints.

In some embodiments, the method includes, before receiving the shaft of the electrical joint in each through hole: placing a first bipole lead sheet on the first surface of the bipole frame such that each first head of the electrical joints is on the first bipole lead sheet; and placing a second bipole lead sheet on the second surface of the bipole frame such that each second head of the electrical joints is on the second bipole lead sheet. The method may further include welding at edge portions of the electrical joints to inhibit crevice corrosion.

In some embodiments, a diameter of the first head and a diameter of the second head are each greater than a diameter of the through hole. The diameter of the first head and the diameter of the second head may each be at least 1.5 times greater than the diameter of the through hole.

In some embodiments, the first head is convex relative to the first surface of the bipole frame, and the second head is convex relative to the second surface of the bipole frame.

Some other embodiments of the present invention are directed to a bipole frame assembly for a bipolar battery. The bipole frame assembly includes: a bipole frame including first and second opposite surfaces and a plurality of through holes; a positive bipole lead sheet on the first surface of the bipole frame; a negative bipole lead sheet on the second surface of the bipole frame; and a plurality of electrical connections with one at each of the plurality of through holes, wherein each electrical connection includes a central portion that fills the through hole, a first head on the first surface of the bipole frame and/or the positive bipole lead sheet, and a second head on the second surface of the bipole frame and/or the negative bipole lead sheet, and wherein each electrical connection includes a tin-lead alloy including less than 10% tin by weight.

In some embodiments, each electrical connection includes a tin-lead alloy including less than 5% tin by weight.

In some embodiments, a diameter of the first head and a diameter of the second head are each greater than a diameter of the through hole. The diameter of the first head and the diameter of the second head may each be at least 1.5 times greater than the diameter of the through hole.

In some embodiments, the first head is convex relative to the first surface of the bipole frame, and the second head is convex relative to the second surface of the bipole frame.

In some embodiments, the positive bipole lead sheet is on the first heads of the electrical connections and the negative bipole lead sheet is on the second heads of the electrical connections.

Some other embodiments of the present invention are directed to a bipolar battery including: a positive end frame; a negative end frame; and a plurality of bipole frame assemblies between the positive end frame and the negative end frame. Each bipolar frame assembly includes: a bipole frame including first and second opposite surfaces and a plurality of through holes; a positive bipole lead sheet on the first surface of the bipole frame; a negative bipole lead sheet on the second surface of the bipole frame; and a plurality of electrical joints with one at each of the plurality of through holes. Each electrical joint includes a central portion that fills the through hole, a first outer portion on the first surface of the bipole frame and between the bipole frame and the positive bipole lead sheet, and a second outer portion on the second surface of the bipole frame and between the bipole frame and the negative bipole lead sheet.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of a bipolar battery according to some embodiments of the present invention.

FIG. 2 is another perspective view of the bipolar battery of FIG. 1.

FIG. 3 is a schematic sectional view of the bipolar battery of FIG. 1.

FIG. 4 is a sectional view of the bipolar battery of FIG. 1.

FIG. 5 is a perspective view of a bipole frame according to some embodiments of the present invention.

FIG. 6 is another perspective view of the bipole frame of FIG. 5.

FIG. 7 is a plan view of a bipole frame assembly according to some embodiments of the present invention.

FIG. 8 is an opposite plan view of the bipole frame assembly of FIG. 7.

FIG. 9 is a side view of an electrical connection or electrical joint in a first (uncompressed) state according to some embodiments of the present invention.

FIG. 10 is an enlarged fragmentary sectional view of the bipole frame assembly of FIG. 7, illustrating the bipole frame and the electrical connection or electrical joint of FIG. 9 in a second (compressed) state according to some embodiments of the present invention.

FIG. 11 is an enlarged fragmentary sectional view of the bipole frame assembly of FIG. 7, illustrating the bipole frame and the electrical connection or electrical joint of FIG. 9 in a second (compressed) state according to some other embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

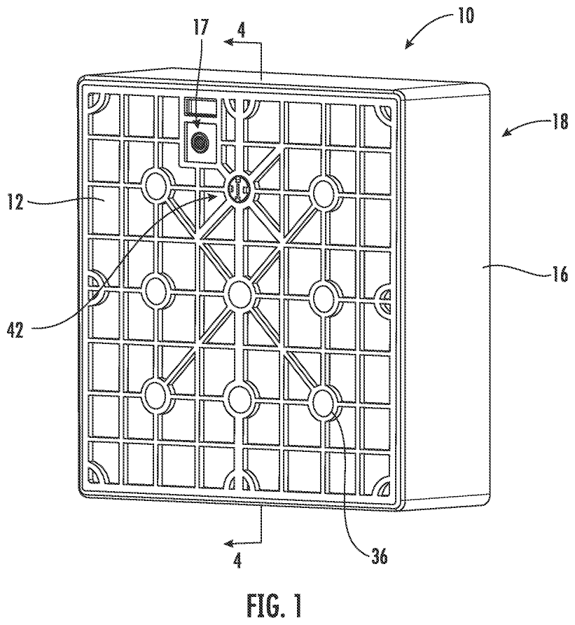

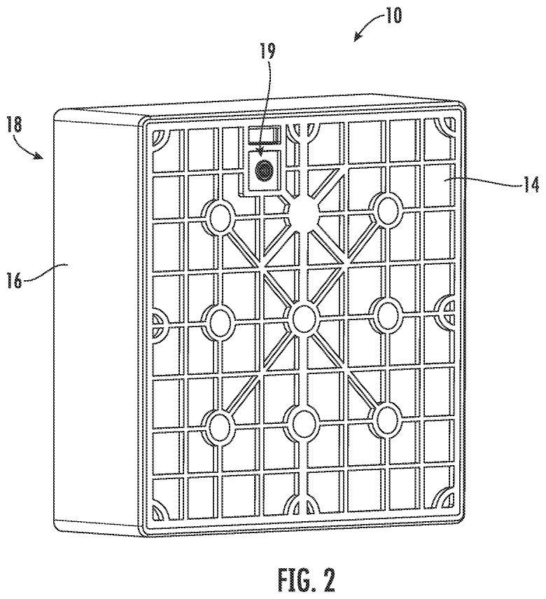

A bipolar battery 10 according to some embodiments is shown in FIGS. 1-4. The battery 10 includes a positive end frame or plate 12, a negative end frame or plate 14, and a central outer casing 16. The positive end frame 12, the negative end frame 14, and the central outer casing 16 may be referred to herein as the battery casing 18.

A positive terminal 17 may be at the positive end frame 12 and a negative terminal 19 may be at the negative end frame 14.

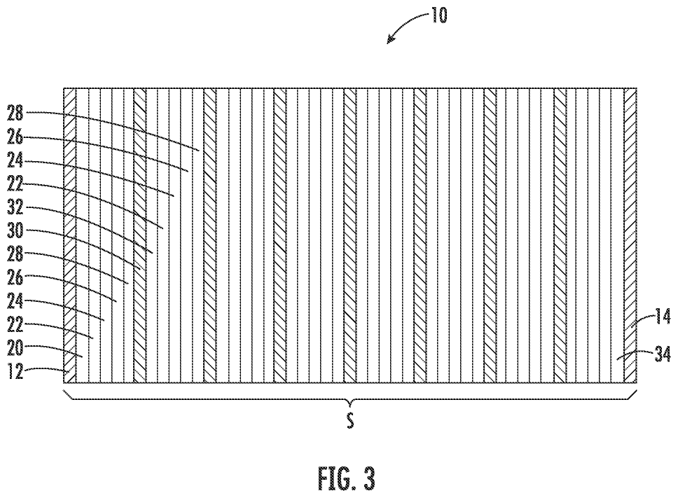

FIG. 3 is a simplified schematic of the bipolar battery 10 with some features omitted including the battery casing. The battery 10 includes a stack S of plates, frames, and/or material layers. Starting at the left side of the drawing, the battery includes the positive end frame 12, a positive end frame lead foil or sheet 20, positive active material (PAM) 22, a separator 24, negative active material (NAM) 26, a negative bipole lead foil or sheet 28, and a bipole frame 30. The next cell or module includes a positive bipole lead foil or sheet 32, the PAM 22, the separator 24, the NAM 26, and the negative bipole lead foil or sheet 28. This same sequence is continued in the stack S until, at the right side of the drawing, there is a negative end frame lead foil or sheet 34 and the negative end frame 14.

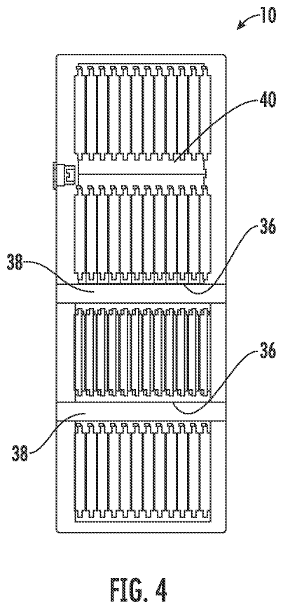

Referring to FIGS. 1 and 4, one or more stabilization channels 36 extend through the stack S. The channels 36 may be defined by aligned holes or apertures defined in the positive end frame 12, the positive end frame lead sheet 20, the negative end frame 14, the negative end frame lead sheet 34, the bipole frames 30, the negative bipole lead sheets 28, and/or the positive bipole lead sheets 32.

A stabilization member 38 may be received in each of the stabilization channels 36. The stabilization members 38 may be a fastener such as a bolt, post, or rod. The stabilization member 38 may be an elongated polymer member that is injected into the channels 36. The stabilization members 38 may provide mechanical stability and strength for the stack S.

Although eight channels 36 and corresponding stabilization members 38 are illustrated, it is contemplated that a lesser or greater number of channels and corresponding stabilization members may be used.

An electrolyte channel or manifold 40 extends at least partially through the stack S. The electrolyte channel 40 may be defined by aligned holes or apertures defined in the positive end frame lead sheet 20, the negative end frame lead sheet 34, the bipole frames 30, the negative bipole lead sheets 28, and/or the positive bipole lead sheets 32. An electrolyte fill port 42 in fluid communication with the electrolyte channel 40 may be on the positive end frame 12. In other embodiments, the fill port 42 may be positioned differently (e.g., on the negative end frame 14).

Each separator 24 may include an electrolyte storage reservoir. The channel 40 may supply electrolyte to each electrolyte storage reservoir.

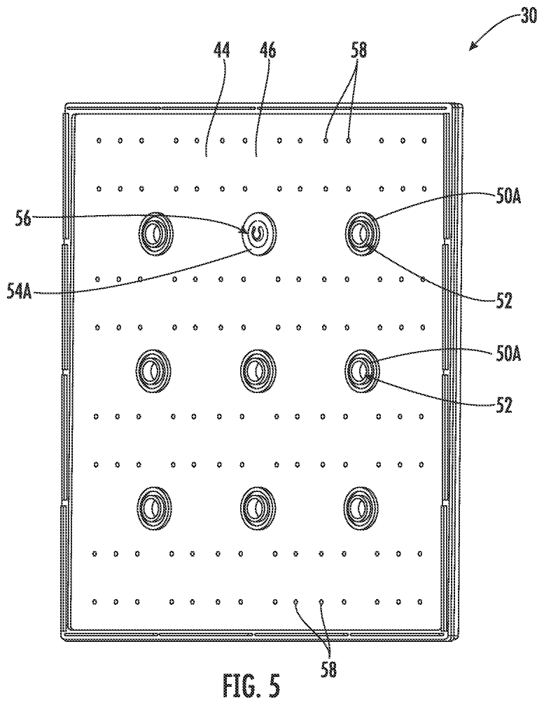

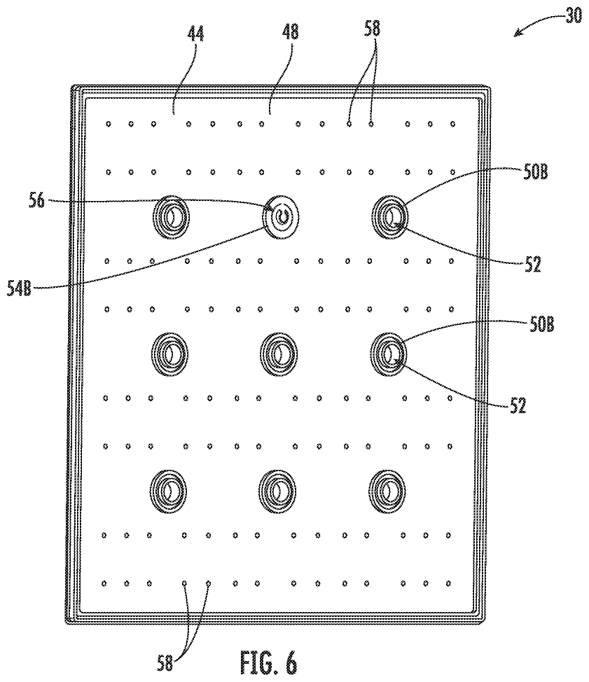

FIGS. 5 and 6 are perspective views of the bipole frame 30. The bipole frame 30 includes a body 44 having first and second opposite primary sides or surfaces 46, 48. The body 44 of the bipole frame 30 may be formed of a polymer such as ABS.

One or more bosses 50A extend outwardly from the first surface 46. One or more bosses 50B extends outwardly from the second surface 48. The bosses 50A, 50B surround stabilization through holes 52 that partially define the stabilization channels 36 described above.

A boss 54A extends outwardly from the first surface 46. A boss 54B extends outwardly from the second surface 48. The bosses 54A, 54B surround an electrolyte through hole 56 that partially defines the electrolyte fill channel 40 described above.

A plurality of through holes 58 extend through the body 44. As described in more detail below, electrical connections are received in the through holes 58 to form a joint for lead sheets on each of the first and second surfaces 46, 48.

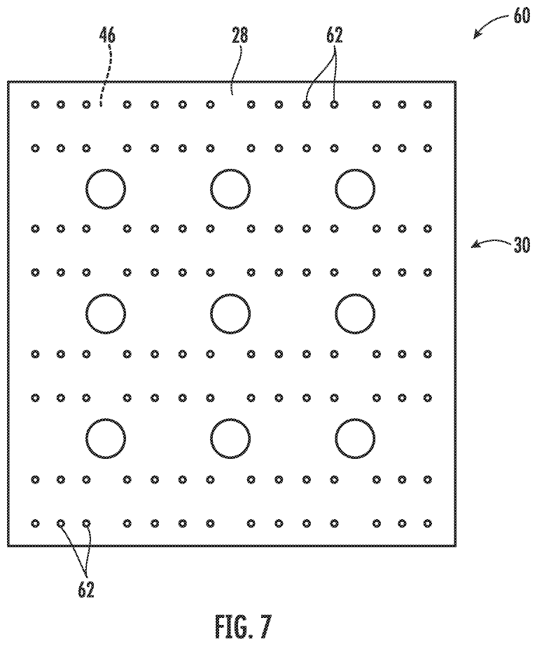

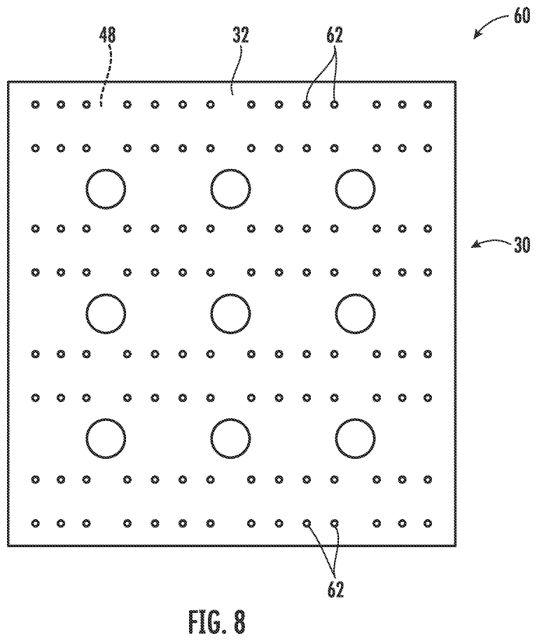

FIGS. 7 and 8 are plan views of the bipole frame assembly 60. The bipole frame assembly 60 includes the bipole frame 30, the negative bipole lead sheet 28 on the first surface 46, and the positive bipole lead sheet 32 on the second surface 48. In some embodiments, an electrical connection or electrical joint 62 is in each of the through holes 58 between the negative bipole lead sheet 28 and the positive bipole lead sheet 32.

The electrical connection 62 in a first (uncompressed) state is illustrated in FIG. 9. The electrical connection 62 includes a barrel or shaft 64 and a first head 66. The shaft 64 includes a proximal end 68 at the first head 66 and an opposite distal end 70. The electrical connection or electrical joint 62 may be referred to herein as a rivet. In some embodiments, the rivet is cast (e.g., cast lead or cast tin-lead alloy with low tin concentration). In other embodiments, cold headed or forged rivets can be used.

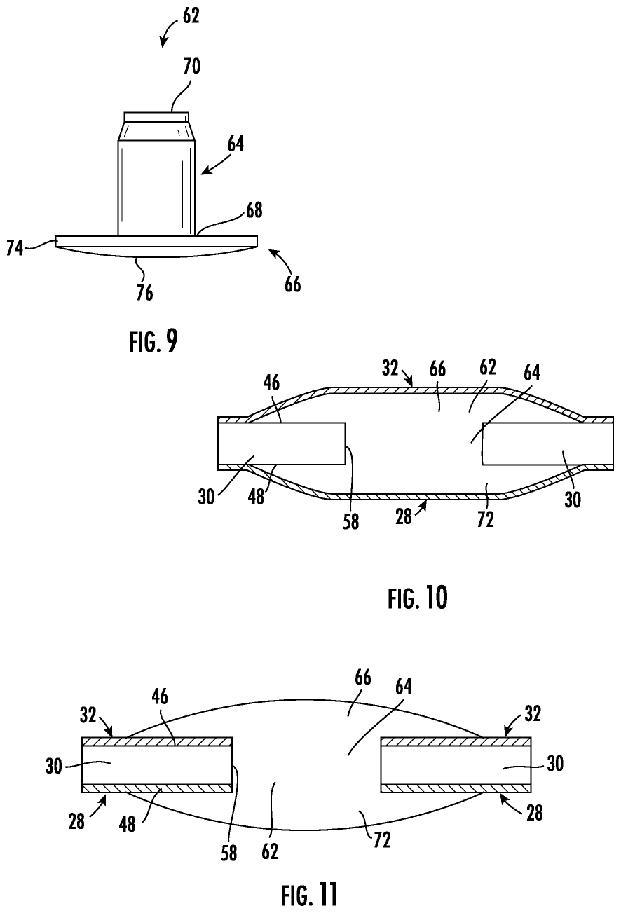

An example process for assembling the bipole frame assembly 60 will now be described with reference to FIGS. 9 and 10. The electrical connection 62 is received in the through hole 58 such that the first head 66 is on one of the first and second surfaces 46, 48 of the bipole frame The electrical connection 62 (e.g., the distal end 70 of the shaft 64) is compressed (e.g., forged) on the bipole frame 30 to form a second head 72 on the other one of the first and second surfaces 46, 48 of the bipole frame 30.

In some embodiments, the positive bipole lead sheet 32 is welded to the first head 66 of the electrical connection 62 and the negative bipole lead sheet 28 is welded to the second head 72 of the electrical connection 62. The welding creates a robust electrical and mechanical connection between the electrical connection 62 and the lead sheets. The welding may be laser welding, resistance welding, or ultrasonic welding. In some other embodiments, the welding may be replaced with another thermal fusion process such as heat staking.

Another example process for assembling the bipole frame assembly 60 will now be described with reference to FIGS. 9 and 11. The positive bipole lead sheet 32 is placed on the first surface 46 of the bipole frame 30 and the negative bipole lead sheet 28 is placed on the second surface 48 of the bipole frame 30. The lead sheets 28, 32 may include through holes that align with the through holes 58 of the bipole frame 30. The electrical connection 62 is received in the through hole 58 such that the first head 66 is on one of the lead sheets 28, 32 (e.g., the positive bipole lead sheet 32). The electrical connection 62 (e.g., the distal end 70 of the shaft 64) is compressed (e.g., forged) on the bipole frame 30 to form a second head 72 on the other one of the lead sheets 28, 32 (e.g., the negative bipole lead sheet 28).

In some embodiments, edge or outer portions of the electrical connection 62 can be welded. The welding can inhibit or prevent crevice corrosion. The welding may be laser welding, resistance welding, or ultrasonic welding. In some other embodiments, the welding may be replaced with another thermal fusion process such as heat staking.

The first head 66 and the second head 72 each have a diameter greater than that of the shaft 64 and the through hole 58. In some embodiments, the diameter of the first head 66 and the second head 72 is at least 1.5 times greater than the diameter of the shaft 64 and the through hole 58. In some other embodiments, the diameter of the first head 66 and the second head 72 is at least two times greater than the diameter of the shaft 64 and the through hole 58.

FIGS. 10 and 11 show the electrical connection or electrical joint 62 in a second (compressed) state. The shaft 64 defines a central portion of the electrical connection 62 and the first and second heads 66, 72 define first and second outer portions of the electrical connection 62. As described above, the shaft 64 (or central portion) completely fills the through hole 58. The compression of the electrical connection 62 may expand (the diameter or width of) the shaft 64 to help ensure that the shaft 64 completely fills the through hole 58. The first and second heads 66, 72 (or first and second outer portions) may include convex outer surfaces.

In some embodiments, the first head 66 of the electrical connection 62 includes a planar sidewall 74 and a convex portion 76 extending from the planar sidewall 74. This configuration may provide for a more robust rivet and prevent cracking or fracture. In some embodiments, the first head 66 (or the preformed rivet head) is installed on the positive side of the bipole frame assembly to provide enhanced protection against corrosion.

Some known bipolar batteries include bipole frame joints are made using a reflowed solder paste process. This joint design has two potential defects caused by an inadequate solder joint fill within the bipole frame substrate: 1) high electrical resistance; and 2) electrolyte communication between adjacent half cells. In addition, solder alloys with low enough reflow temperatures to work with polymer bipole frames have been shown to have higher corrosion rates.

According to embodiments of the present invention, the reflowed solder paste connection is replaced with a solid rivet connection joining the lead foil on both sides of the bipole frame. The connection between the lead foil and the rivet can be made by lead compression and/or welding.

The solid rivets are compressed or forged to ensure that the through holes of the bipole frame are completely filled to prevent electrolyte leaks. In contrast, even if the through hole is completely filled with solder paste, the reflow process has inherent porosity issues due to flux vaporization potentially causing voids.

This rivet connection design allows for the use of low tin concentration tin-lead alloys. This minimizes lead corrosion and maximizes the joint life. In some embodiments, the electrical connection (rivet) is formed of a tin-lead alloy having less than 10% tin by weight (or 10% or less tin by weight). In some other embodiments, the electrical connection (rivet) is formed of a tin-lead alloy having less than 5% tin by weight (or 5% or less tin by weight). The electrical connection (rivet) may include at least one grain refiner such as selenium, copper, nickel, and/or tellurium.

The solid rivet joint ensures a complete fill of the bipole frame through hole which will minimize electrical resistance and reduce electrolyte leakage frequency and rate. In addition, the rivet head increases the foil to through hole connection area thereby reducing overall resistance between the lead foil and the rivet barrel or shaft as compared to the reflowed solder joint design. Further, the rivet head may increase the strength of the joint by decreasing the stress concentration around the joint's perimeter. Finally, the rivet construction allows the use of lower tin concentration alloys.

The electrical connection according to embodiments of the present invention can facilitate bipolar batteries with longer life applications (e.g., 5-10 year service life) as compared to the current design.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A method of assembling a bipole frame assembly for a bipolar battery, the method comprising:
providing a bipole frame comprising first and second opposite surfaces and a plurality of through holes;
receiving a shaft of a solid electrical joint in each through hole such that a first head of the electrical joint is on the first surface of the bipole frame; and
compressing a distal end of the shaft to form a second head of the electrical joint that is on the second surface of the bipole frame and to completely fill the through hole with the shaft.

2. The method of claim 1 further comprising:
placing a first bipole lead sheet on the first surface of the bipole frame and each first head of the electrical joints; and
placing a second bipole lead sheet on the second surface of the bipole frame and each second head of the electrical joints.

3. The method of claim 2 further comprising welding at the electrical joints to enhance a connection between the first and second lead sheets and the electrical joints.

4. The method of claim 1 further comprising, before receiving the shaft of the electrical joint in each through hole:
placing a first bipole lead sheet on the first surface of the bipole frame such that each first head of the electrical joints is on the first bipole lead sheet; and
placing a second bipole lead sheet on the second surface of the bipole frame such that each second head of the electrical joints is on the second bipole lead sheet.

5. The method of claim 4 further comprising welding at edge portions of the electrical joints to inhibit crevice corrosion.

6. The method of claim 1 wherein a diameter of the first head and a diameter of the second head are each greater than a diameter of the through hole.

7. The method of claim 6 wherein the diameter of the first head and the diameter of the second head are each at least 1.5 times greater than the diameter of the through hole.

8. The method of claim 1 wherein the first head is convex relative to the first surface of the bipole frame, and wherein the second head is convex relative to the second surface of the bipole frame.

9. A bipole frame assembly for a bipolar battery, the bipole frame assembly comprising:
a bipole frame comprising first and second opposite surfaces and a plurality of through holes;
a positive bipole lead sheet on the first surface of the bipole frame;
a negative bipole lead sheet on the second surface of the bipole frame; and
a plurality of electrical connections with one at each of the plurality of through holes,
wherein each electrical connection comprises a central portion that fills the through hole, a first head on the first surface of the bipole frame and/or the positive bipole lead sheet, and a second head on the second surface of the bipole frame and/or the negative bipole lead sheet, and
wherein each electrical connection comprises a tin-lead alloy comprising less than 10% tin by weight.

10. The bipole frame assembly of claim 9 wherein each electrical connection comprises a tin-lead alloy comprising less than 5% tin by weight.

11. The bipole frame assembly of claim 9 wherein a diameter of the first head and a diameter of the second head are each greater than a diameter of the through hole.

12. The bipole frame assembly of claim 11 wherein the diameter of the first head and the diameter of the second head are each at least 1.5 times greater than the diameter of the through hole.

13. The bipole frame assembly of claim 9 wherein the first head is convex relative to the first surface of the bipole frame, and wherein the second head is convex relative to the second surface of the bipole frame.

14. The bipole frame assembly of claim 9 wherein the positive bipole lead sheet is on the first heads of the electrical connections and the negative bipole lead sheet is on the second heads of the electrical connections.

15. A bipolar battery comprising:
a positive end frame;
a negative end frame; and
a plurality of bipole frame assemblies between the positive end frame and the negative end frame,
wherein each bipolar frame assembly comprises:
a bipole frame comprising first and second opposite surfaces and a plurality of through holes;
a positive bipole lead sheet on the first surface of the bipole frame;
a negative bipole lead sheet on the second surface of the bipole frame; and
a plurality of electrical joints with one at each of the plurality of through holes,
wherein each electrical joint comprises a central portion that fills the through hole, a first outer portion on the first surface of the bipole frame and between the bipole frame and the positive bipole lead sheet, and a second outer portion on the second surface of the bipole frame and between the bipole frame and the negative bipole lead sheet.
